(19) United States
(12) Patent Application Publication
(10) Pub. No.: US 2026/0245350 A1
(43) Pub. Date: Aug. 20, 2026

(54) FEATURE ALIGNMENT FOR MULTI-CAMERA BIRD'S EYE VIEW FUSION

(71) Applicant: QUALCOMM Incorporated, San Diego, CA (US)

(72) Inventors: Kiran Bangalore Ravi, Paris (FR); Andrei Stefan Bulzan, Timisoara (RO); Varun Ravi Kumar, San Diego, CA (US); Senthil Kumar Yogamani, San Diego, CA (US)

(21) Appl. No.: 19/055,219

(22) Filed: Feb. 17, 2025

(51) Int. Cl. G06V 10/80; G06T 17/05; G06V 10/62; G06V 10/764; G06V 10/77; G06V 10/82; G06V 10/98; G06V 20/58; G06V 20/64

(52) U.S. Cl. CPC G06V 10/806; G06T 17/05; G06V 10/62; G06V 10/764; G06V 10/7715; G06V 20/58; G06V 20/64; G06T 2200/08; G06T 2210/56; G06V 10/82; G06V 10/98; G06V 2201/10

(57) ABSTRACT

A method for time of capture (ToC) compensation of bird's eye view (BEV) features includes obtaining sensor data generated by one or more sensors of a vehicle, wherein the sensor data includes images from a plurality of cameras, and wherein at least two of the images have different ToCs. The method further includes extracting, from the sensor data, BEV features of the images. The method further includes comparing overlapping features of the BEV features. The method further includes applying ToC compensation to the BEV features based on comparing the overlapping features to generate compensated BEV features.

### TECHNICAL FIELD

This disclosure relates to image processing.

### BACKGROUND

Among other challenges, autonomous driving systems need to accurately detect and track moving objects such as vehicles, pedestrians, and cyclists in real time. In autonomous driving, accurately estimating the state of surrounding obstacles may be important for safe and robust path planning. However, this perception task is difficult, particularly due to distortive effects of vehicle motion and reliance on sensor data from multiple sources. For example, multimodal perception datasets may include sensor data from surround view cameras, front and rear long-range cameras, light detection and ranging (LiDAR) sensors, radars, or any subset or combination of the foregoing sensor types. Distortions may produce perceptual errors that can manifest as braking and swerving maneuvers which may be unsafe and uncomfortable.

### SUMMARY

Sensor architectures on autonomous driving and other vehicles may include one or more LiDAR sensors and a plurality of cameras (e.g., surround view cameras, long range cameras, etc.). Camera features may be modified or distorted due to different time of captures (ToCs) even though the cameras'start of frames may be synced. This can affect performance of perception tasks, such as three-dimensional (3D) object detection and bird's eye view (BEV) segmentation, that use BEV features extracted from cameras with different ToCs.

This disclosure describes techniques for ToC compensation of BEV features from camera inputs with different ToCs to improve perception quality. According to the techniques of this disclosure, redundant and overlapping regions of cameras are used to infer ToC compensation adjustments to BEV features extracted from images captured by the cameras.

In one example, a method for ToC compensation of BEV features includes obtaining sensor data generated by one or more sensors of a vehicle, wherein the sensor data includes images from a plurality of cameras, and wherein at least two of the images have different ToCs. The method further includes extracting, from the sensor data, BEV features of the images. The method further includes comparing overlapping features of the BEV features. The method further includes applying ToC compensation to the BEV features based on comparing the overlapping features to generate compensated BEV features.

In another example, an apparatus for ToC compensation of BEV features includes a memory for storing sensor data. The apparatus further includes processing circuitry in communication with the memory. The processing circuitry is configured to obtain the sensor data generated by one or more sensors of a vehicle, wherein the sensor data includes images from a plurality of cameras, and wherein at least two of the images have different ToCs. The processing circuitry is further configured to extract, from the sensor data, BEV features of the images. The processing circuitry is further configured to compare overlapping features of the BEV features. The processing circuitry is further configured to apply ToC compensation to the BEV features based on comparing the overlapping features to generate compensated BEV features.

In yet another example, a non-transitory computer-readable storage medium has instructions encoded thereon. The instructions are configured to cause processing circuitry to obtain sensor data generated by one or more sensors of a vehicle, wherein the sensor data includes images from a plurality of cameras, and wherein at least two of the images have different ToCs. The instructions are further configured to cause the processing circuitry to extract, from the sensor data, BEV features of the images. The instructions are further configured to cause the processing circuitry to compare overlapping features of the BEV features. The instructions are further configured to cause the processing circuitry to apply ToC compensation to the BEV features based on comparing the overlapping features to generate compensated BEV features.

The details of one or more examples are set forth in the accompanying drawings and the description below. Other features, objects, and advantages will be apparent from the description, drawings, and claims.

### BRIEF DESCRIPTION OF DRAWINGS

FIG. 1 is a diagram of an example autonomous vehicle, in accordance with the techniques of this disclosure.

FIG. 2 is a block diagram illustrating an example system that may perform the techniques of this disclosure.

FIG. 3 is a block diagram further illustrating the example system of FIG. 2.

FIG. 4 is a block diagram further illustrating the example system of FIGS. 2 and 3.

FIG. 5 illustrates overlapping camera regions in a BEV space.

FIG. 6 is a flowchart illustrating an example method for ToC compensation of BEV features, in accordance with the techniques of this disclosure.

### DETAILED DESCRIPTION

Autonomous driving systems and/or advanced driving assistance systems (ADAS) rely on various sensors like cameras, LiDAR, radar, etc., each with its strengths and weaknesses. Cameras may provide rich visual information but may struggle in low light or challenging weather. LiDAR may offer accurate distance measurements but may have limited range or be sensitive to rain. Radar may excel at detecting objects in all weather conditions but may lack detailed visual information. A sensor data fusion approach combines sensor data before any high-level processing like object detection or classification takes place. The goal of the sensor data fusion is to create a more comprehensive and robust understanding of the environment by leveraging the combined strengths of different sensors.

A common representation used in sensor data fusion is the BEV space. BEV stands for bird's eye view. The BEV space is a representation of the 3D world from a top-down perspective, similar to looking down at a map.

Sensor architectures on autonomous driving and other vehicles may include one or more LiDAR sensors and a plurality of cameras (e.g., surround view cameras, long range cameras, etc.). Object shape deformation due to vehicle motion in LiDAR point clouds are corrected by vehicle motion compensation. However, camera features may be modified or distorted due to different times of capture (ToCs) even though the cameras'start of frames may be synced. This can affect performance of perception tasks, such as three-dimensional (3D) object detection and BEV segmentation, that use BEV features extracted from cameras with different ToCs.

Applying motion compensation to point cloud data may be used due to the benefits it brings in accuracy. For example, motion compensation applied to point cloud data may bring points at the exact time of capture of another sensor and combat elongated objects owing to sweeping patterns. However, the motion compensation techniques used to correct LiDAR point clouds may not resolve ToC differences that affect BEV features extracted from images taken by different cameras.

ToC may refer to the moment in time when the real world gets imprinted onto a camera sensor. In this regard, the ToC of an image can be defined as a time stamp at which an image (e.g., an image's pixel row for rolling shutter cameras) gets captured by the camera sensor. It may be at that time that the real world is instantiated or perceived by the sensor. Different cameras may have different operating mechanisms, but they all generally share concepts like start of capture, exposure time, a camera readout time, etc.

Length of capture may refer to the time it takes from the beginning of an image's start of capture and until it reaches its final sensing row. ToC may sometimes be simplified in its concept as being somewhere at approximately 40% to 50% of the total length of capture or duration of capture. For example, if it takes reading all rows of an image 100 ms, to simplify things where accuracy is not on the micro level, it may be possible to approximate ToC of that image at around start of capture time plus 40 ms to 50 ms (e.g., an average time of when the whole image was perceived).

Exposure time, on the other hand, may refer to the duration that each row (or group of rows) of the camera sensor is exposed to light. This is one mechanism that contributes to the total length of capture, but other factors may also contribute to the total length of capture, such as readout time (e.g., a delay in time between reading consecutive pixel rows in an image) and sensor reset overhead (e.g., some sensors may have row resetting or analog to digital conversion that adds delays between exposure and readout).

This disclosure describes techniques for ToC compensation of BEV features from camera inputs with different ToCs to improve perception quality. BEV features may be extracted per camera and reprojected into a vehicle-referenced BEV. Traditional BEV fusion temporarily places BEV features per camera at different ToCs because the features may be perceived by respective camera sensors at different time stamps regardless of whether start of capture is synchronized. This may lead to poor intermediate fusion with LiDAR BEV features. BEV features extracted per camera may also look different from one another based on exposure time per camera, which may affect ToC. Additionally, high exposure can lead to motion blur at the cost of higher intensity.

According to techniques of this disclosure, redundant and overlapping regions of cameras are used to infer ToC compensation adjustments to BEV features extracted from images captured by the cameras. The BEV features may be aligned to a target camera/image and thus all brought to a target ToC (i.e., the ToC of the target camera/image). Aligning the BEV features to a target ToC may combat rolling shutter negative effects as well as other camera-intrinsic time-sync problems. The ToC compensation techniques disclosed herein may also nullify effects of variable camera exposure contributing to each camera having a different ToC, irrespective of start of capture.

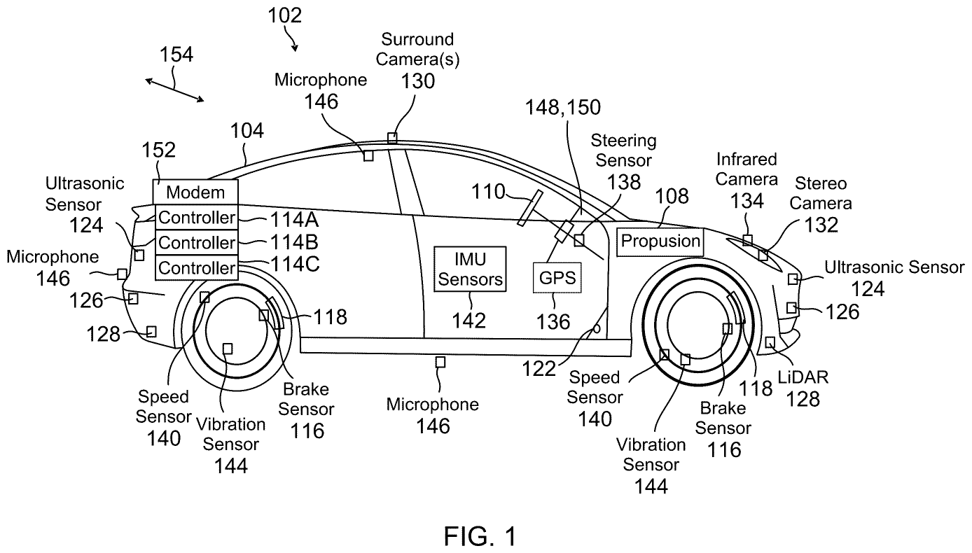

FIG. 1 shows an example vehicle 102. Vehicle 102 in the example shown may comprise a passenger vehicle such as a car or truck that can accommodate a human driver and/or human passengers. In some examples, vehicle 102 may comprise an autonomous vehicle, semi-autonomous vehicle and/or vehicle with an ADAS. Vehicle 102 may include a vehicle body 104 suspended on a chassis, in this example comprised of four wheels and associated axles. A propulsion system 108 such as an internal combustion engine, hybrid electric power plant, or even all-electric engine may be connected to drive some or all of the wheels via a drive train, which may include a transmission (not shown). A steering wheel 110 may be used to steer some or all of the wheels to direct vehicle 102 along a desired path when the propulsion system 108 is operating and engaged to propel the vehicle 102. Steering wheel 110 or the like may be optional for Level 5 implementations. One or more controllers 114A-114C (a controller 114) may provide autonomous capabilities in response to signals continuously provided in real-time from an array of sensors, as described more fully below.

Each controller 114 may be essentially one or more onboard computers that may be configured to perform deep learning and/or artificial intelligence functionality and output autonomous operation commands to self-drive vehicle 102 and/or assist the human vehicle driver in driving. Each vehicle may have any number of distinct controllers for functional safety and additional features. For example, controller 114A may serve as the primary computer for autonomous driving functions, controller 114B may serve as a secondary computer for functional safety functions, controller 114C may provide artificial intelligence functionality for in-camera sensors, and controller 114D (not shown) may provide infotainment functionality and provide additional redundancy for emergency situations.

Controller 114 may send command signals to operate vehicle brakes 116 via one or more braking actuators 118, operate steering mechanism via a steering actuator, and operate propulsion system 108 which also receives an accelerator/throttle actuation signal 122. Actuation may be performed by methods known to persons of ordinary skill in the art, with signals typically sent via the Controller Area Network data interface (“CAN bus”)—a network inside modern cars used to control brakes, acceleration, steering, windshield wipers, and the like. The CAN bus may be configured to have dozens of nodes, each with its own unique identifier (CAN ID). The bus may be read to find steering wheel angle, ground speed, engine RPM, button positions, and other vehicle status indicators. The functional safety level for a CAN bus interface is typically Automotive Safety Integrity Level (ASIL) B. Other protocols may be used for communicating within a vehicle, including FlexRay and Ethernet.

In some examples, an actuation controller may be obtained with dedicated hardware and software, allowing control of throttle, brake, steering, and shifting. The hardware may provide a bridge between the vehicle's CAN bus and the controller 114, forwarding vehicle data to controller 114 including the turn signal, wheel speed, acceleration, pitch, roll, yaw, Global Positioning System (“GPS”) data, tire pressure, fuel level, sonar, brake torque, and others. Similar actuation controllers may be configured for any other make and type of vehicle, including special-purpose patrol and security cars, robo-taxis, long-haul trucks including tractor-trailer configurations, tiller trucks, agricultural vehicles, industrial vehicles, and buses.

Controller 114 may provide autonomous driving outputs in response to an array of sensor inputs including, for example: one or more ultrasonic sensors 124, one or more RADAR sensors 126, one or more LiDAR sensors 128, one or more surround cameras 130 (typically such cameras are located at various places on vehicle body 104 to image areas all around the vehicle body), one or more stereo cameras 132 (in some examples, at least one such stereo camera may face forward to provide object recognition in the vehicle path), one or more infrared cameras 134, GPS unit 136 that provides location coordinates, a steering sensor 138 that detects the steering angle, speed sensors 140 (one for each of the wheels), an inertial sensor or inertial measurement unit (“IMU”) 142 that monitors movement of vehicle body 104 (this sensor can be for example an accelerometer(s) and/or a gyro-sensor(s) and/or a magnetic compass(es)), tire vibration sensors 144, and microphones 146 placed around and inside the vehicle. Other sensors may be used, as is known to persons of ordinary skill in the art.

Controller 114 may also receive inputs from an instrument cluster 148 and may provide human-perceptible outputs to a human operator via human-machine interface (“HMI”) display(s) 150, an audible annunciator, a loudspeaker and/or other means. In addition to traditional information such as velocity, time, and other well-known information, HMI display 150 may provide the vehicle occupants with information regarding maps and vehicle's location, the location of other vehicles (including an occupancy grid) and even the Controller's identification of objects and status. For example, HMI display 150 may alert the passenger when the controller has identified the presence of a stop sign, caution sign, or changing traffic light and is taking appropriate action, giving the vehicle occupants peace of mind that the controller 114 is functioning as intended.

In some examples, instrument cluster 148 may include a separate controller/processor configured to perform deep learning and artificial intelligence functionality.

Vehicle 102 may collect data that is used to help train and refine the neural networks used for autonomous driving. The vehicle 102 may include modem 152, preferably a system-on-a-chip that provides modulation and demodulation functionality and allows the controller 114 to communicate over the wireless network 154. Modem 152 may include an RF front-end for up-conversion from baseband to RF, and down-conversion from RF to baseband, as is known in the art. Frequency conversion may be achieved either through known direct-conversion processes (direct from baseband to RF and vice-versa) or through super-heterodyne processes, as is known in the art. Alternatively, such RF front-end functionality may be provided by a separate chip. Modem 152 preferably includes wireless functionality substantially compliant with one or more wireless protocols such as, without limitation: LTE, WCDMA, UMTS, GSM, CDMA2000, or other known and widely used wireless protocols.

Compared to sonar and RADAR sensors 126, cameras 130-134 may generate a richer set of features at a fraction of the cost. Vehicle 102 may include a plurality of cameras 130-134, capturing images around the entire periphery of the vehicle 102. Camera type and lens selection depends on the nature and type of function. For example, some of the surround cameras 130 may be fisheye cameras. Fisheye cameras are a type of wide-angle lens that may be used in vehicles to provide a broader view of the surroundings than a traditional rearview mirror or camera. Fisheye cameras typically have a viewing angle of around 170 degrees or even up to 180 degrees, which can be very helpful for tasks such as, but not limited to: parking, backing up, blind spot monitoring, etc. The vehicle 102 may have a mix of camera types and lenses to provide complete coverage around the vehicle 102; in general, narrow lenses do not have a wide field of view but can see farther. All camera locations on the vehicle 102 may support interfaces such as Gigabit Multimedia Serial link (GMSL) and Gigabit Ethernet.

In examples of this disclosure, a controller 114 may start by gathering data generated by one or more sensors 126-134 of the vehicle 102. For example, sensors may include cameras 130-134, LiDAR sensors 128, RADAR sensors 126, or a subset or combination of these sensors. The sensor data may include images captured by a plurality of cameras (e.g., surround cameras 130), wherein at least two of the images have different ToCs. Controller 114 may extract, from the sensor data, BEV features of the images. For example, controller 114 may extract, from the sensor data, perspective view features of the images and then project the perspective view features onto a BEV space representing an environment surrounding vehicle 102. Controller 114 may then compare overlapping features of the BEV features. For example, controller 114 may detect the overlapping features and align them based on a target ToC. The target ToC may be associated with a particular one of the cameras (e.g., the ToC of an image from a specified one of the surround cameras 130). Controller 114 may apply ToC compensation to the BEV features based on a comparison (e.g., detection and alignment) of the overlapping features. For example, controller 114 may determine a ToC compensation transform for the BEV features based said comparison and then apply the ToC compensation transform to the BEV features. In some examples, the ToC compensation transform is determined based on maximizing overlap and alignment of BEV features.

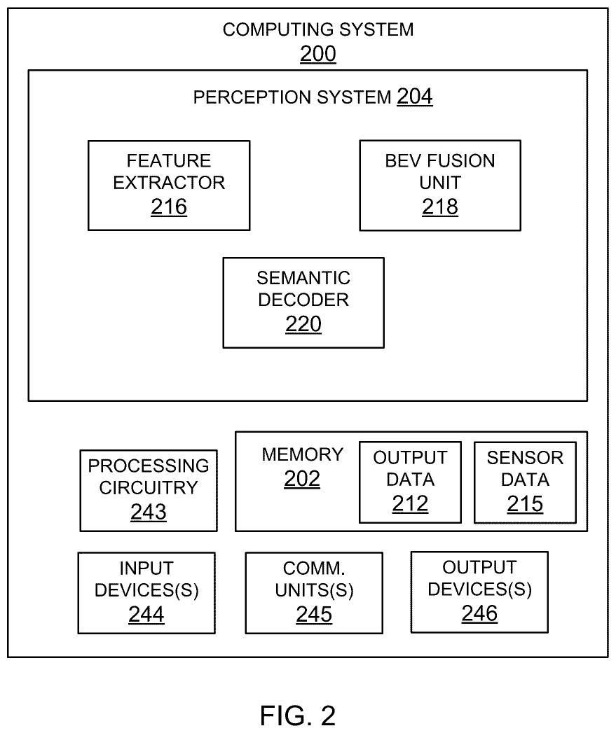

FIG. 2 is a block diagram illustrating an example computing system 200. As shown, computing system 200 comprises processing circuitry 243 and memory 202 for executing perception system 204, including feature extractor 216, BEV fusion unit 218, and semantic decoder 220 which may represent an example instance of any controller 114 described in this disclosure, such as controller 114 of FIG. 1. Perception system 204 may be a component of an autonomous driving system, such as ADAS. In some examples, perception system 204 comprises a machine learning (ML) system (not shown) which may include various types of neural networks, such as, but not limited to, recursive neural networks (RNNs), convolutional neural networks (CNNs), and deep neural networks (DNNs). The ML system may also include an object detection model.

Computing system 200 may also be implemented as any suitable external computing system accessible by controller 114, such as one or more server computers, workstations, laptops, mainframes, cloud computing systems, High-Performance Computing (HPC) systems (i.e., supercomputing) and/or other computing systems that may be capable of performing operations and/or functions described in accordance with one or more examples of the present disclosure. In some examples, computing system 200 may represent a cloud computing system, server farm, and/or server cluster (or portion thereof) that provides services to client devices and other devices or systems. In other examples, computing system 200 may represent or be implemented through one or more virtualized compute instances (e.g., virtual machines, containers, etc.) of a data center, cloud computing system, server farm, and/or server cluster.

The techniques described in this disclosure may be implemented, at least in part, in hardware, software, firmware or any combination thereof. For example, various aspects of the described techniques may be implemented within processing circuitry 243 of computing system 200, which may include one or more of a microprocessor, a controller, a digital signal processor (DSP), an application specific integrated circuit (ASIC), a field-programmable gate array (FPGA), or equivalent discrete or integrated logic circuitry, or other types of processing circuitry. The term “processor” or “processing circuitry” may generally refer to any of the foregoing logic circuitry, alone or in combination with other logic circuitry, or any other equivalent circuitry. A control unit comprising hardware may also perform one or more of the techniques of this disclosure.

Computing system 200 may comprise any suitable computing system having one or more computing devices, such as desktop computers, laptop computers, handheld devices, tablets, mobile telephones, smartphones, etc. In some examples, at least a portion of computing system 200 is distributed across a cloud computing system, a data center, or across a network, such as the Internet, another public or private communications network, for instance, broadband, cellular, Wi-Fi, ZigBee, Bluetooth® (or other personal area network—PAN), Near-Field Communication (NFC), ultrawideband, satellite, enterprise, service provider and/or other types of communication networks, for transmitting data between computing systems, servers, and computing devices.

Memory 202 may comprise one or more storage devices. One or more components of computing system 200 (e.g., processing circuitry 243, memory 202, etc.) may be interconnected to enable inter-component communications (physically, communicatively, and/or operatively). In some examples, such connectivity may be provided by a system bus, a network connection, an inter-process communication data structure, local area network, wide area network, or any other method for communicating data. Processing circuitry 243 of computing system 200 may implement functionality and/or execute instructions associated with computing system 200. Examples of processing circuitry 243 include microprocessors, application processors, display controllers, auxiliary processors, one or more sensor hubs, and any other hardware configured to function as a processor, a processing unit, or a processing device. Computing system 200 may use processing circuitry 243 to perform operations in accordance with one or more examples of the present disclosure using software, hardware, firmware, or a mixture of hardware, software, and firmware residing in and/or executing at computing system 200. The one or more storage devices of memory 202 may be distributed among multiple devices.

Memory 202 may store information for processing during operation of computing system 200. In some examples, memory 202 comprises temporary memories, meaning that a primary purpose of the one or more storage devices of memory 202 is not long-term storage. Memory 202 may be configured for short-term storage of information as volatile memory and therefore not retain stored contents if deactivated. Examples of volatile memories include random access memories (RAM), dynamic random-access memories (DRAM), static random-access memories (SRAM), and other forms of volatile memories known in the art. Memory 202, in some examples, may also include one or more computer-readable storage media. Memory 202 may be configured to store larger amounts of information than volatile memory. Memory 202 may further be configured for long-term storage of information as non-volatile memory space and retain information after activate/off cycles. Examples of non-volatile memories include magnetic hard disks, optical discs, Flash memories, or forms of electrically programmable memories (EPROM) or electrically erasable and programmable (EEPROM) memories. Memory 202 may store program instructions and/or data associated with one or more of the modules or units described in accordance with one or more examples of this disclosure.

Processing circuitry 243 and memory 202 may provide an operating environment or platform for one or more modules or units (e.g., feature extractor 216, BEV fusion unit 218, and semantic decoder 220), which may be implemented as software, but may in some examples include any combination of hardware, firmware, and software. Processing circuitry 243 may execute instructions and the one or more storage devices, e.g., memory 202, may store instructions and/or data of one or more modules or units. The combination of processing circuitry 243 and memory 202 may retrieve, store, and/or execute the instructions and/or data of one or more applications, modules, or software. The processing circuitry 243 and/or memory 202 may also be operably coupled to one or more other software and/or hardware components, including, but not limited to, one or more of the components illustrated in FIG. 2.

Processing circuitry 243 may execute perception system 204 using virtualization modules, such as a virtual machine or container executing on underlying hardware. One or more of such modules may execute as one or more services of an operating system or computing platform. Aspects of perception system 204 may execute as one or more executable programs at an application layer of a computing platform.

One or more input devices 244 of computing system 200 may generate, receive, or process input. Such input may include input from a video camera, sensor, keyboard, pointing device, voice responsive system, biometric detection/response system, button, mobile device, control pad, microphone, presence-sensitive screen, network, or any other type of device for detecting input from a human or machine.

One or more output devices 246 may generate, transmit, or process output. Examples of output are tactile, audio, visual, and/or video output. Output devices 246 may include a display, sound card, video graphics adapter card, speaker, presence-sensitive screen, one or more USB interfaces, video and/or audio output interfaces, or any other type of device capable of generating tactile, audio, video, or other output. Output devices 246 may include a display device, which may function as an output device using technologies including liquid crystal displays (LCD), quantum dot display, dot matrix displays, light emitting diode (LED) displays, organic light-emitting diode (OLED) displays, cathode ray tube (CRT) displays, e-ink, or monochrome, color, or any other type of display capable of generating tactile, audio, and/or visual output. In some examples, computing system 200 may include a presence-sensitive display that may serve as a user interface device that operates both as one or more input devices 244 and one or more output devices 246.

One or more communication units 245 of computing system 200 may communicate with devices external to computing system 200 (or among separate computing devices of computing system 200) by transmitting and/or receiving data, and may operate, in some respects, as both an input device and an output device. In some examples, communication units 245 may communicate with other devices over a network. In other examples, communication units 245 may send and/or receive radio signals on a radio network such as a cellular radio network. Examples of communication units 245 include a network interface card (e.g., such as an Ethernet card), an optical transceiver, a radio frequency transceiver, a GPS receiver, or any other type of device that can send and/or receive information. Other examples of communication units 245 may include Bluetooth®, GPS, 3G, 4G, 5G and Wi-Fi® radios found in mobile devices as well as Universal Serial Bus (USB) controllers and the like.

In the example of FIG. 2, feature extractor 216 may be configured to extract features from sensor data 215, as described herein. Feature extractor 216 may receive input from sensors such as, but not limited to, cameras 130-134, LiDAR sensor(s) 128, RADAR sensors 126, and/or ultrasonic sensors 124. Output data generated by feature extractor 216 (e.g., BEV features) may be used as input data for BEV fusion unit 218 of the perception system 204. Sensor data 215 may contain various types of information. For example, sensor data 215 may include, but is not limited to, camera image data, LiDAR point cloud data, and so on. Semantic decoder 220 may generate output data 212 based on information received from BEV fusion unit 218. In some examples, semantic decoder 220 may predict class labels (e.g., lane, car, pedestrian) of detected objects, providing a semantic understanding of the environment. Alternatively, semantic decoder 220 may predict the type, location, and size (3D bounding box) of objects present in a scene from a BEV representation. Output data 212 generated by semantic decoder 220 may include, but is not limited to, a BEV space feature map.

Feature extractor 216 may receive images from a plurality of cameras. Feature extractor 216 then extracts BEV features of the images. As previously discussed, BEV features from images captured by different cameras may have different ToCs regardless of whether the cameras'start of capture times were synchronized. This may affect performance of perception tasks, such as 3D object detection and BEV segmentation. BEV fusion unit 218 may apply ToC compensation to extracted BEV features to improve perception quality, as described below.

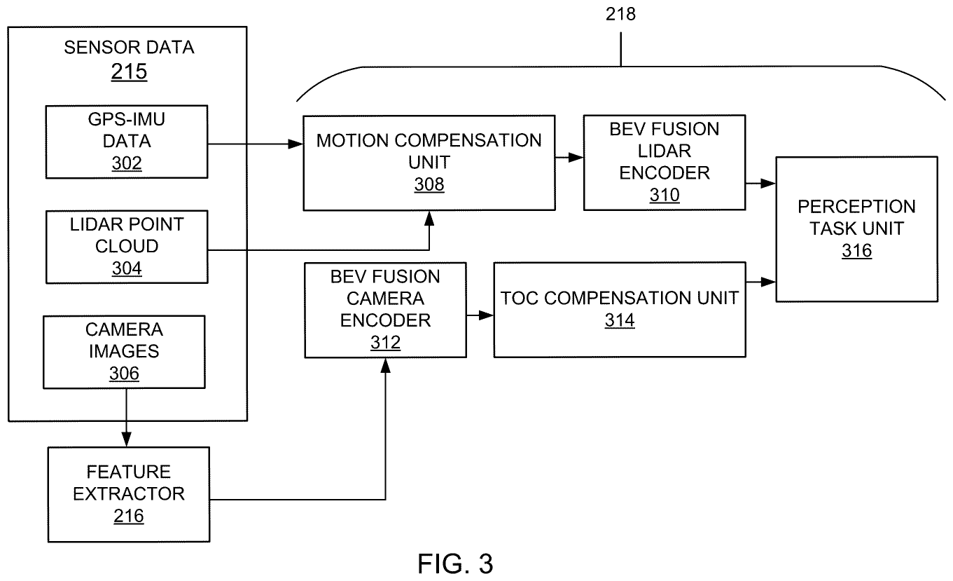

FIG. 3 is a block diagram illustrating an example of BEV fusion unit 218 in accordance with this disclosure. BEV fusion unit 218 may include a motion compensation unit 308, a BEV fusion LiDAR encoder 310, a BEV fusion camera encoder 312, a ToC compensation unit 314, and a perception task unit 316. According to techniques of this disclosure, BEV fusion unit 218 may apply motion compensation to a LiDAR point cloud data 304 (from one or more LiDAR sensors 128) and ToC compensation to BEV features extracted from camera images 306 (from a plurality of cameras, such as surround cameras 130).

BEV fusion unit 218 may be configured to perform motion compensation for LiDAR point cloud data 304 based on global positioning system inertial measurement unit (GPS-IMU) data 302 (e.g., vehicle poses, orientation, trajectory, velocity, acceleration, etc.). For example, sensor data 215 including GPS-IMU data 302 and LiDAR point cloud data 304 may be provided as inputs to motion compensation unit 308. Motion compensation unit 308 may assume that LiDAR sensor 128 has constant angular and linear velocities and, accordingly, that the effect of the vehicle motion on LiDAR point cloud data 304 is linear. Accordingly, motion compensation unit 308 may estimate a correction for each data point in LiDAR point cloud data 304 using vehicle odometry (i.e., GPS-IMU data 302). Motion compensation unit 308 may apply the correction estimated for each data point in LiDAR point cloud data 304. BEV fusion LiDAR encoder 310 then encodes information received from motion compensation unit 308 and outputs compensated LiDAR point cloud data 304 (including compensated LiDAR BEV features).

As previously discussed, BEV features extracted from camera images 306 may be affected by differences in ToC from one image to the next. To resolve such differences, BEV fusion unit 218 is configured to perform ToC compensation for BEV features extracted from camera images 306.

Feature extractor 216 may extract features from the camera images 306, wherein at least two of the camera images 306 are from different cameras (e.g., different ones of surround cameras 130) and have different ToCs. In some examples, BEV fusion camera encoder 312 receives perspective view features extracted by feature extractor 216 from camera images 306 and then projects the perspective view features onto a BEV space representing an environment surrounding vehicle 102. BEV fusion camera encoder 312 then outputs BEV features (i.e., the extracted features that have been projected onto the BEV space).

In order to calculate transforms for feature overlap and motion compensation, it may be helpful to maintain image source information for the BEV features. To accomplish this, feature extractor 216 and BEV fusion camera encoder 312 may perform individual BEV extraction, whereby, features are tagged with image source information after the features are extracted and projected onto the BEV space, as described above. For example, BEV fusion camera encoder 312 may be configured to store image source information in metadata for the BEV features output by the BEV fusion camera encoder 312 (e.g., in respective metadata for each BEV feature or cluster of features). In some examples, feature extractor 216 may also be configured to tag (e.g., store image source information in metadata for) of perspective view features that are projected onto the BEV space to generate the resulting BEV features. The image source information may indicate a camera (e.g., one of the surround cameras 130) that was used to capture a respective one of the BEV features. This technique is possible because BEV projection is generally performed per-camera and then brought into the common global frame. For example, perspective view features may be extracted from a first camera image, projected onto the BEV space, and tagged as BEV features from a first camera; perspective view features may be extracted from a second camera image, projected onto the BEV space, and tagged as BEV features from a second camera; and so on. BEV fusion camera encoder 312 may output the extracted BEV features in a unified BEV dataset with each feature or cluster of features being tagged with image source information (e.g., in the respective metadata of each feature or cluster of features).

BEV fusion unit 218 may compare overlapping features of the BEV features and then apply ToC compensation to the BEV features based on comparing the overlapping features. For example, ToC compensation unit 314 may receive the BEV features output by BEV fusion camera encoder 312.

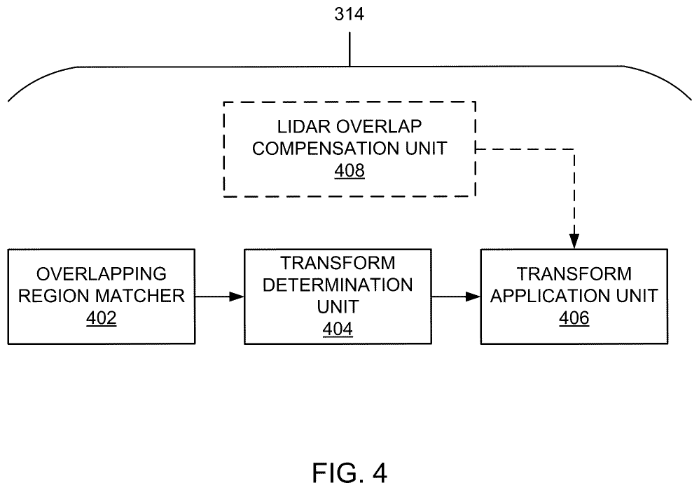

FIG. 4 is a block diagram illustrating an example of ToC compensation unit 314 in accordance with this disclosure. ToC compensation unit 314 may include an overlapping region matcher 402, a transform determination unit 404, and a transform application unit 406. Overlapping region matcher 402 may detect overlapping regions/features of camera images 306 from different cameras (e.g., overlapping BEV features extracted from images from respective ones of the surround cameras 130). Transform determination unit 404 may determine ToC compensation transforms (e.g., mathematical corrections or functions) for BEV features based on comparing overlapping features to align said features to a target ToC. Transform application unit 406 then applies ToC compensation transforms to the extracted BEV features to bring them all to the target ToC. Accordingly, ToC compensation unit 314 detects overlapping BEV features and then aligns the overlapping features based on a target ToC.

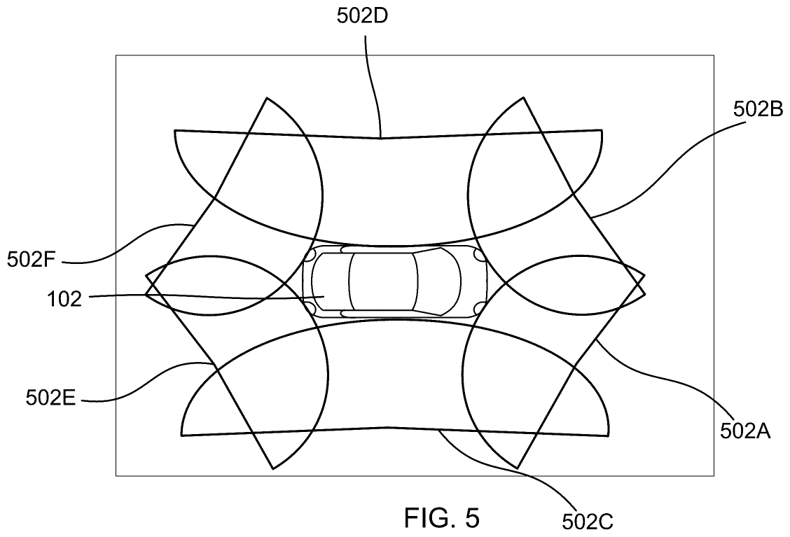

Overlapping features are BEV features that can be seen in overlapping regions of multiple camera images 306. For example, FIG. 5 illustrates regions 502A-502F surrounding vehicle 102 that may include overlapping BEV features. In other examples, the number of overlapping regions and their positioning may be different than the regions 502A-502F illustrated in FIG. 5. Overlapping regions of camera images 306 will be dependent upon the number of cameras (e.g., surround cameras 130), field of view (FOV) characteristics of the cameras, and their positions with respect to one another and with respect to vehicle 102. The target ToC corresponds to the ToC of a selected camera or image. ToC compensation unit 314 may determine a ToC compensation transform for the BEV features based comparing (e.g., detecting and aligning) the overlapping features and may then apply the ToC compensation transform to the BEV features. In some examples, the ToC compensation transform is determined based on maximizing overlap and alignment of BEV features.

In an example, the surround cameras 130 include one long-range forward (LR FW) camera, one long-range backward (LR BW) camera, and four short range (SR) surround cameras (e.g., surround drive perception (SDP) cameras), and wherein the LR FW camera ToC is selected as the target ToC. In this context, to compare overlapping features of the BEV features, ToC compensation unit 314 may: (1) detect overlapping BEV features from a first set of overlapping cameras (front surround, left surround, and right surround cameras) and align them to overlapping features of the LR FW camera; and (2) detect overlapping BEV features from a second set of overlapping cameras (back surround and LR BW cameras) and align them to overlapping features of the LR FW camera using left surround and right surround overlap from step (1).

In the example described above, overlapping features between LR FW camera and SDP left, right, and front cameras serve as targets for alignment. Based on alignment characteristics of the overlapping features, ToC compensation unit 314 may determine a ToC compensation transform for the BEV features. This technique is further exemplified below using BEV edge features.

In an example, ToC compensation unit 314 may compare BEV edge features of LR FW and SDP front cameras, determine a ToC compensation transform that maximizes the overlap between localized feature clusters of the overlapping image regions, and apply the ToC compensation transform to the remainder of BEV features captured by the SDP front camera to bring those features to the LR FW ToC. ToC compensation unit 314 may also take BEV edge features of SDP front camera (or LR FW camera, whichever has a wider FOV, or use both) and compare them to BEV edge features of SDP left camera, determine a ToC compensation transform that maximizes the overlap between localized feature clusters of the overlapping image regions, and apply the ToC compensation transform to the remainder of BEV features captured by the SDP left camera to bring those features to the LR FW ToC. ToC compensation unit 314 may also take BEV edge features of SDP front camera (or LR FW camera, whichever has a wider FOV, or use both) and compare them to BEV edge features of SDP right camera, determine a ToC compensation transform that maximizes the overlap between localized feature clusters of the overlapping image regions, and apply the ToC compensation transform to the remainder of BEV features captured by the SDP right camera to bring those features to the LR FW ToC. ToC compensation unit 314 may also take BEV edge features of SDP rear camera and compare them to BEV edge features of SDP right and SDP left cameras, determine a ToC compensation transform that maximizes the overlap between localized feature clusters of the overlapping image regions, and apply the ToC compensation transform to the remainder of BEV features captured by the SDP rear camera to bring those features to the LR FW ToC. ToC compensation unit 314 may take BEV edge features of SDP rear camera and compare them to BEV edge features of LR BW camera, determine a ToC compensation transform that maximizes the overlap between localized feature clusters of the overlapping image regions, and apply the ToC compensation transform to the remainder of BEV features captured by the LR BW camera to bring those features to the LR FW ToC.

In some examples, ToC compensation unit 314 treats dynamic objects (aka clusters) differently than static objects for more accuracy during transform. ToC compensation unit 314 may use heuristics or existing information about dynamic characteristics of objects to separate the transforms being applied to static and non-static objects.

In some examples, the ToC compensation is at least partially based on LiDAR point cloud data 304. For example, as shown in FIG. 4, ToC compensation unit 314 may further include a LiDAR overlap compensation unit 408. LiDAR overlap compensation unit 408 may utilize LiDAR point cloud data 304 to bridge the gap between BEV features extracted from camera images 306. For example, LiDAR point cloud data 304 can be used to amplify the effect of BEV features motion compensation by projecting lidar points (at the target ToC) into the BEV camera view and calculating a transform of overlapping regions to minimize offset to the projected point cloud clusters. This may increase resilience and reduce artifacts/errors that relying solely on camera features may introduce.

Referring again to FIG. 3, perception task unit 316 may receive BEV features extracted from the camera images 306 after performing ToC compensation on the BEV features. Perception task unit 316 may perform 3D objection detection and/or BEV segmentation utilizing the compensated BEV features as inputs. In some examples, motion compensated LiDAR point cloud data 304 and/or BEV features extracted from LiDAR point cloud data 304 are also provided as inputs to the perception task unit 316.

In some examples, perception task unit 316 or semantic decoder 220 may generate a vehicle referenced BEV image including the BEV features. Additionally, in some examples, perception task unit 316 or semantic decoder 220 may generate output data 212, such as a BEV space feature map, that can be used to operate a vehicle system (e.g., ADAS) based on the BEV features. In some examples, perception task unit 316 may be a unit or module of the semantic decoder 220.

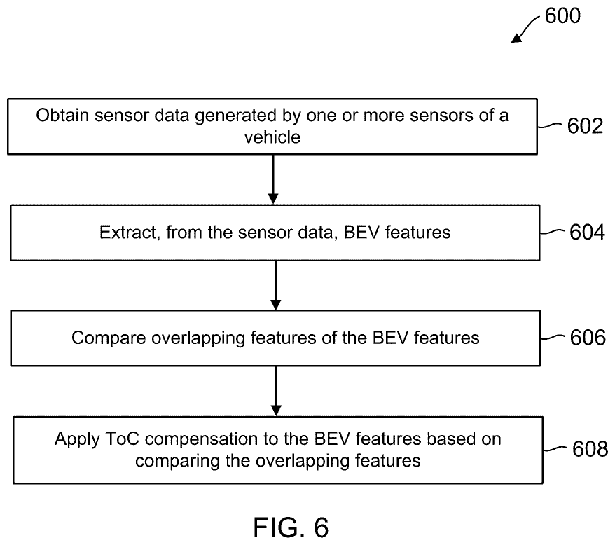

FIG. 6 is a flowchart illustrating an example method 600 for time of capture (ToC) compensation of BEV features, in accordance with the techniques of this disclosure. Although described with respect to computing system 200 (FIG. 2), it should be understood that other devices may be configured to perform a method similar to that of FIG. 6.

In the example of FIG. 6, perception system 204 may start by gathering data generated by one or more sensors of the vehicle 102 (602). For example, sensor data 215 may include images captured by a plurality of cameras (e.g., surround cameras 130), wherein at least two of the images have different ToCs. Perception system 204 may extract, from the sensor data 215, BEV features of the images (604). For example, perception system 204 may extract, from the sensor data 215, perspective view features of the images and then project the perspective view features onto a BEV space representing an environment surrounding a vehicle (e.g., vehicle 102). In some examples, perception system 204 tags the BEV features with image source information, wherein the image source information indicates a camera that was used to capture a respective one of the BEV features. For example, perception system 204 may encode the image source information in metadata for the BEV features. After extracting BEV features from the sensor data 215, perception system 204 may compare overlapping features of the BEV features (606). For example, perception system may detect the overlapping features and align them based on a target ToC. The target ToC may be associated with a particular one of the cameras (e.g., the ToC of an image from a specified one of the surround cameras 130). Perception system 204 may apply ToC compensation to the BEV features based on a comparison (e.g., detection and alignment) of the overlapping features (608). For example, perception system 204 may determine a ToC compensation transform for the BEV features based said comparison and then apply the ToC compensation transform to the BEV features to generate compensated BEV features. In some examples, the ToC compensation transform is determined based on maximizing overlap and alignment of BEV features.

In some examples of method 600, the sensor data 215 further includes a LiDAR point cloud. Perception system 204 may utilize the LiDAR point cloud to apply ToC compensation. For example, perception system 204 may apply further corrections/transforms to the BEV features based on the LiDAR point cloud.

In some examples of method 600, perception system 204 may generate a vehicle referenced BEV image including the BEV features. Additionally, in some examples, perception system 204 may generate output data 212, such as a BEV space feature map, that can be used to operate a vehicle system (e.g., ADAS) based on the BEV features.

The following numbered clauses illustrate one or more aspects of the devices and techniques described in this disclosure.

Clause 1. A method for time of capture (ToC) compensation of bird's eye view (BEV) features includes: obtaining sensor data generated by one or more sensors of a vehicle, wherein the sensor data includes images from a plurality of cameras, and wherein at least two of the images have different ToCs; extracting, from the sensor data, BEV features of the images; comparing overlapping features of the BEV features; and applying ToC compensation to the BEV features based on comparing the overlapping features to generate compensated BEV features.

Clause 2. The method of clause 1, wherein extracting, from the sensor data, the BEV features of the images includes: extracting, from the sensor data, perspective view features of the images; and projecting the perspective view features onto a BEV space representing an environment surrounding the vehicle.

Clause 3. The method of any of clauses 1 and 2, further including: tagging the BEV features with image source information, wherein the image source information indicates a camera that was used to capture one or more of the BEV features.

Clause 4. The method of clause 3, wherein the image source information is encoded in metadata for the BEV features.

Clause 5. The method of any of clauses 1-4, wherein comparing the overlapping features of the BEV features includes: detecting the overlapping features of the BEV features; and aligning the overlapping features based on a target ToC.

Clause 6. The method of any of clauses 1-5, wherein applying the ToC compensation to the BEV features based on comparing the overlapping features includes: determining a ToC compensation transform for the BEV features based on comparing the overlapping features; and applying the ToC compensation transform to the BEV features.

Clause 7. The method of any of clauses 1-6, wherein the sensor data further includes a light detection and ranging (LiDAR) point cloud, and wherein the ToC compensation is at least partially based on the LiDAR point cloud.

Clause 8. The method of any of clauses 1-7, wherein the method further includes generating a BEV image including the compensated BEV features.

Clause 9. The method of any of clauses 1-8, wherein the method further includes operating an Advanced Driver Assistance System (ADAS) based on the compensated BEV features.

Clause 10. An apparatus for time of capture (ToC) compensation of bird's eye view (BEV) features includes: a memory for storing sensor data and processing circuitry in communication with the memory, wherein the processing circuitry is configured to: obtain the sensor data generated by one or more sensors of a vehicle, wherein the sensor data includes images from a plurality of cameras, and wherein at least two of the images have different ToCs; extract, from the sensor data, BEV features of the images; compare overlapping features of the BEV features; and apply ToC compensation to the BEV features based on comparing the overlapping features to generate compensated BEV features.

Clause 11. The apparatus of clause 10, wherein to extract, from the sensor data, the BEV features of the images, the processing circuitry is configured to: extract, from the sensor data, perspective view features of the images; and project the perspective view features onto a BEV space representing an environment surrounding the vehicle.

Clause 12. The apparatus of any of clauses 10 and 11, wherein the processing circuitry is further configured to tag the BEV features with image source information, wherein the image source information indicates a camera that was used to capture one or more of the BEV features.

Clause 13. The apparatus of clause 12, wherein the image source information is encoded in metadata for the BEV features.

Clause 14. The apparatus of any of clauses 10-13, wherein to compare the overlapping features of the BEV features, the processing circuitry is configured to: detect the overlapping features of the BEV features; and align the overlapping features based on a target ToC.

Clause 15. The apparatus of any of clauses 10-14, wherein to apply the ToC compensation to the BEV features based on comparing the overlapping features, the processing circuitry is configured to: determine a ToC compensation transform for the BEV features based on comparing the overlapping features; and apply the ToC compensation transform to the BEV features.

Clause 16. The apparatus of any of clauses 10-15, wherein the sensor data further includes a light detection and ranging (LiDAR) point cloud, and wherein the ToC compensation is at least partially based on the LiDAR point cloud.

Clause 17. The apparatus of any of clauses 10-16, wherein the processing circuitry is further configured to generate a BEV image including the compensated BEV features.

Clause 18. The apparatus of any of clauses 10-17, wherein the processing circuitry is further configured to operate an Advanced Driver Assistance System (ADAS) system based on the compensated BEV features.

Clause 19. The apparatus of any of clauses 10-18, comprising a vehicle that includes the memory and the processing circuitry.

Clause 20. A non-transitory computer-readable storage medium having instructions encoded thereon, the instructions configured to cause processing circuitry to: obtain sensor data generated by one or more sensors of a vehicle, wherein the sensor data includes images from a plurality of cameras, and wherein at least two of the images have different time of captures (ToCs); extract, from the sensor data, bird's eye view (BEV) features of the images; compare overlapping features of the BEV features; and apply ToC compensation to the BEV features based on comparing the overlapping features to generate compensated BEV features.

It is to be recognized that depending on the example, certain acts or events of any of the techniques described herein can be performed in a different sequence, may be added, merged, or left out altogether (e.g., not all described acts or events are necessary for the practice of the techniques). Moreover, in certain examples, acts or events may be performed concurrently, e.g., through multi-threaded processing, interrupt processing, or multiple processors, rather than sequentially.

In one or more examples, the functions described may be implemented in hardware, software, firmware, or any combination thereof. If implemented in software, the functions may be stored on or transmitted over as one or more instructions or code on a computer-readable medium and executed by a hardware-based processing unit. Computer-readable media may include computer-readable storage media, which corresponds to a tangible medium such as data storage media, or communication media including any medium that facilitates transfer of a computer program from one place to another, e.g., according to a communication protocol. In this manner, computer-readable media generally may correspond to (1) tangible computer-readable storage media which is non-transitory or (2) a communication medium such as a signal or carrier wave. Data storage media may be any available media that can be accessed by one or more computers or one or more processors to retrieve instructions, code and/or data structures for implementation of the techniques described in this disclosure. A computer program product may include a computer-readable medium.

By way of example, and not limitation, such computer-readable storage media may include one or more of RAM, ROM, EEPROM, CD-ROM or other optical disk storage, magnetic disk storage, or other magnetic storage devices, flash memory, or any other medium that can be used to store desired program code in the form of instructions or data structures and that can be accessed by a computer. Also, any connection is properly termed a computer-readable medium. For example, if instructions are transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. It should be understood, however, that computer-readable storage media and data storage media do not include connections, carrier waves, signals, or other transitory media, but are instead directed to non-transitory, tangible storage media. Disk and disc, as used herein, includes compact disc (CD), laser disc, optical disc, digital versatile disc (DVD), floppy disk and Blu-ray disc, where disks usually reproduce data magnetically, while discs reproduce data optically with lasers. Combinations of the above should also be included within the scope of computer-readable media.

Instructions may be executed by one or more processors, such as one or more DSPs, general purpose microprocessors, ASICs, FPGAs, or other equivalent integrated or discrete logic circuitry. Accordingly, the terms “processor” and “processing circuitry,” as used herein may refer to any of the foregoing structures or any other structure suitable for implementation of the techniques described herein. In addition, in some aspects, the functionality described herein may be provided within dedicated hardware and/or software modules or units configured for encoding and decoding or incorporated in a combined codec. Also, the techniques could be fully implemented in one or more circuits or logic elements.

The techniques of this disclosure may be implemented in a wide variety of devices or apparatuses, including a wireless handset, an integrated circuit (IC) or a set of ICs (e.g., a chip set). Various components, modules, or units are described in this disclosure to emphasize functional aspects of devices configured to perform the disclosed techniques, but do not necessarily require realization by different hardware units. Rather, as described above, various units may be combined in a codec hardware unit or provided by a collection of interoperative hardware units, including one or more processors as described above, in conjunction with suitable software and/or firmware.

Various examples have been described. These and other examples are within the scope of the following claims.

What is claimed is:

1. A method for time of capture (ToC) compensation of bird's eye view (BEV) features, the method comprising:
obtaining sensor data generated by one or more sensors of a vehicle, wherein the sensor data includes images from a plurality of cameras, and wherein at least two of the images have different ToCs;
extracting, from the sensor data, BEV features of the images;
comparing overlapping features of the BEV features; and
applying ToC compensation to the BEV features based on comparing the overlapping features to generate compensated BEV features.

2. The method of claim 1, wherein extracting, from the sensor data, the BEV features of the images comprises:
extracting, from the sensor data, perspective view features of the images; and
projecting the perspective view features onto a BEV space representing an environment surrounding the vehicle.

3. The method of claim 1, further comprising:
tagging the BEV features with image source information, wherein the image source information indicates a camera that was used to capture one or more of the BEV features.

4. The method of claim 3, wherein the image source information is encoded in metadata for the BEV features.

5. The method of claim 1, wherein comparing the overlapping features of the BEV features comprises:
detecting the overlapping features of the BEV features; and
aligning the overlapping features based on a target ToC.

6. The method of claim 1, wherein applying the ToC compensation to the BEV features based on comparing the overlapping features comprises:
determining a ToC compensation transform for the BEV features based on comparing the overlapping features; and
applying the ToC compensation transform to the BEV features.

7. The method of claim 1, wherein the sensor data further includes a light detection and ranging (LiDAR) point cloud, and wherein the ToC compensation is at least partially based on the LiDAR point cloud.

8. The method of claim 1, further comprising:
generating a BEV image including the compensated BEV features.

9. The method of claim 1, further comprising:
operating an Advanced Driver Assistance System (ADAS) based on the compensated BEV features.

10. An apparatus for time of capture (ToC) compensation of bird's eye view (BEV) features, the apparatus comprising:
a memory for storing sensor data; and
processing circuitry in communication with the memory, wherein the processing circuitry is configured to:
obtain the sensor data generated by one or more sensors of a vehicle, wherein the sensor data includes images from a plurality of cameras, and wherein at least two of the images have different ToCs;
extract, from the sensor data, BEV features of the images;
compare overlapping features of the BEV features; and
apply ToC compensation to the BEV features based on comparing the overlapping features to generate compensated BEV features.

11. The apparatus of claim 10, wherein to extract, from the sensor data, the BEV features of the images, the processing circuitry is configured to:
extract, from the sensor data, perspective view features of the images; and
project the perspective view features onto a BEV space representing an environment surrounding the vehicle.

12. The apparatus of claim 10, wherein the processing circuitry is further configured to:
tag the BEV features with image source information, wherein the image source information indicates a camera that was used to capture one or more of the BEV features.

13. The apparatus of claim 12, wherein the image source information is encoded in metadata for the BEV features.

14. The apparatus of claim 10, wherein to compare the overlapping features of the BEV features, the processing circuitry is configured to:
detect the overlapping features of the BEV features; and
align the overlapping features based on a target ToC.

15. The apparatus of claim 10, wherein to apply the ToC compensation to the BEV features based on comparing the overlapping features, the processing circuitry is configured to:
determine a ToC compensation transform for the BEV features based on comparing the overlapping features; and
apply the ToC compensation transform to the BEV features.

16. The apparatus of claim 10, wherein the sensor data further includes a light detection and ranging (LiDAR) point cloud, and wherein the ToC compensation is at least partially based on the LiDAR point cloud.

17. The apparatus of claim 10, wherein the processing circuitry is further configured to:
generate a BEV image including the compensated BEV features.

18. The apparatus of claim 10, wherein the processing circuitry is further configured to:
operate an Advanced Driver Assistance System (ADAS) based on the compensated BEV features.

19. The apparatus of claim 10, further comprising a vehicle including the memory and the processing circuitry.

20. A non-transitory computer-readable storage medium having instructions encoded thereon, the instructions configured to cause processing circuitry to:
obtain sensor data generated by one or more sensors of a vehicle, wherein the sensor data includes images from a plurality of cameras, and wherein at least two of the images have different time of captures (ToCs);
extract, from the sensor data, bird's eye view (BEV) features of the images;
compare overlapping features of the BEV features; and
apply ToC compensation to the BEV features based on comparing the overlapping features to generate compensated BEV features.
